(19) United States
(12) Patent Application Publication
(10) Pub. No.: US 2023/0250603 A1
(43) Pub. Date: Aug. 10, 2023

(54) Power Generation System and Method

(71) Applicant: Hans Gude Gudesen, Gamle Fredrikstad (NO)

(72) Inventor: Hans Gude Gudesen, Gamle Fredrikstad (NO)

(21) Appl. No.: 18/005,259

(22) PCT Filed: Jun. 17, 2021
(86) PCT No.: PCT/NO2021/050147

§ 371 Date: Jan. 12, 2023

(30) Foreign Application Priority Data
Jul. 13, 2020 (NO) 20200823

(51) Int. Cl. E02B 9/06; F03B 13/06

(52) U.S. Cl. CPC E02B 9/06; F03B 13/06; F05B 2210/13

(57) ABSTRACT

A multiphase fluid pressurized hydroelectric power generation system is disclosed. The system comprises a combination of fluids in the liquid and gas phase in contact with each other, a plurality of water reservoirs where at least one is a closeable water reservoir comprising a closeable volume i.e. a confined space where all fluid flow in and out is controlled, and a source of pressurized fluid arranged for supplying pressurized fluid to the at least one closeable water reservoir. A corresponding method is also disclosed.

### FIELD OF THE INVENTION

The present invention relates to a system and a method for deriving electrical energy from thermal and other sources.

### BACKGROUND OF THE INVENTION

A large fraction of the world's electrical energy supply is currently generated by steam turbines where the steam is generated by combustion of fossil fuel. This is harmful to the environment and contributes to global warming, and considerable efforts have been spent worldwide to harness other types of heat sources, in particular geothermal, solar and waste heat recovery. Unfortunately, such resources worldwide are generally limited in their ability to deliver steam at the temperatures where turbines can operate efficiently. Technical solutions exist, e.g. Organic Rankin Cycle (ORC), that provide electrical power from low grade heat, i.e. at temperatures in the range 65-350 C, but at a high cost in complexity and efficiency.

### Objects of the Present Invention

Accordingly, it is a major objective of the present invention to introduce novel concepts and techniques for electrical energy generation from steam or gas at elevated pressures.

It is a further major objective of the present invention to introduce novel concepts and techniques for electrical energy generation from steam or gas pressurized by employing low grade heat sources.

### Means for Solving the Problems

The objects are achieved according to the invention by a system and a method according to independent claims.

A number of non-exhaustive embodiments, variants or alternatives of the invention are defined by the dependent claims.

### SUMMARY OF THE INVENTION

A first aspect of the inventions is a multiphase fluid pressurized hydroelectric power generation system, comprising:
a combination of fluids in the liquid and gas phase in contact with each other;
a plurality of water reservoirs where at least one is a closeable water reservoir comprising a closeable volume i.e. a confined space where all fluid flow in and out is controlled;
a source of pressurized fluid arranged for supplying pressurized fluid to the at least one closeable water reservoir;
the at least one closeable water reservoir arranged to contain water under an atmosphere of pressurized gas or vapor,
a turbine with a generator for generating hydroelectric power;
the plurality of water reservoirs comprising a first and a second water reservoir, where the second water reservoir is a closable water reservoir;
a first and a second turbine water conduit arranged respectively between the first water reservoir and the turbine, and the turbine and the second reservoir; and
a control system arranged for coordinated control of the hydroelectric power generation system, comprising means for controlling fluid flow between different parts of the system.

Optionally, the system comprises a riser conduit leading from a lower part of the second water reservoir to a higher altitude, where the riser conduit optionally debouches into the first water reservoir.

Optionally, the system comprises means for introduction of at least one of gas and steam bubbles in the riser conduit, by one or more of the following: Direct injection at one or more points in the riser conduit; and nucleation or boiling in the riser conduit, and transport of bubbles or dissolved gas in water from the second water reservoir.

Optionally, the pressurized fluid comprises at least one of steam, dry gas and hot water, where the source of pressurized fluid optionally is a geothermal source or a combustion process.

Optionally, the source of pressurized fluid comprises a closable storage volume for storing hot water and steam under pressure, with conduits leading into the first and/or second water reservoir, where the closable storage volume optionally comprises means for receiving thermal energy from an energy source in the form of hot water, steam, flue gas or an electric heater.

Optionally, the system comprises at least one additional second water reservoir which is closeable, and a turbine water conduit arranged between the turbine and the additional second water reservoir; where the control means is arranged for sequential or staggered use of the second water reservoirs.

Optionally, the first water reservoir is closeable, where the first water reservoir optionally is located at a higher altitude than the second water reservoir, and arranged to be pressurized based on pressurized fluid supplied by a source of pressurized fluid, and where the system comprises a riser conduit as described above.

Optionally, the turbine is arranged for being driven by water flow between two reservoirs that alternate as the first and second water reservoirs, and there is no riser conduit, where the source of pressurized fluid optionally is common to both water reservoirs.

A second aspect of the invention is a multiphase fluid pressurized hydroelectric power generation method, comprising a first and a second step cyclically repeated a number of times:

In the first step:
allowing water from a first water reservoir passing via conduits through a turbine with a generator for generating hydroelectric power, and into a second water reservoir forming a closable volume; and
venting the second water reservoir in at least parts of the first step;

In the second step:
suspending the venting of the second water reservoir; and
supplying pressurized fluid from a pressurized fluid source to the second water reservoir contributing to pressing water out of the second water reservoir.

In the second step, optionally, the pressing of water out of the second water reservoir comprises leading water through a riser conduit from a lower part of the second water reservoir to a higher altitude, and optionally comprises introducing at least one of gas and steam bubbles in the riser conduit.

Optionally, the supplying pressurized fluid comprises storing hot water and steam under pressure in a closable storage volume and leading it into at least the second water reservoir.

Optionally, the second water reservoir and at least one additional second water reservoir are used sequentially or staggered from cycle to cycle.

Optionally, where the first water reservoir forms a closable volume, the method comprises

In the first step:
suspending venting of the first water reservoir; and
supplying pressurized fluid from a pressurized fluid source to the first water reservoir enhancing hydraulic pressure in the conduit leading to the turbine;

In the second step:
suspending the supplying pressurized fluid to the first reservoir;
venting the first water reservoir; and
pressing water out of the second water reservoir via the riser conduit and into the first reservoir.

Optionally, where the first water reservoir forms a closable volume, the method comprises:

In the first step:
suspending venting of the first water reservoir;
supplying pressurized fluid from a pressurized fluid source to the first water reservoir enhancing hydraulic pressure in the conduit leading to the turbine; and
allowing water from the first water reservoir passing via the conduit through the turbine with the generator for generating hydroelectric power, and into the second water reservoir;

In the second step:
suspending the supplying pressurized fluid to the first reservoir;
venting the first water reservoir; and
allowing water from the second water reservoir passing via the conduit through the turbine with the generator for generating hydroelectric power, and into the first water reservoir.

Optionally, the method comprises guiding of steam or gas from the venting of at least one of the first and the second water reservoir through a turbine for extracting mechanical energy.

Optionally, where the first water reservoir forms a closable volume, the method comprises:

In the first step:
closing the volume of the first water reservoir by shutting a venting valve and a draining valve of the second reservoir
opening a venting valve of the second water reservoir
shutting off the connection to a pressurized fluid source to the second reservoir by closing a source valve
supplying pressurized fluid from a pressurized fluid source to the first reservoir enhancing the hydraulic pressure in the conduit leading to the turbine;
collecting water that has passed through the turbine in the second reservoir, and

In the second step:
shutting off the connection to a pressurized fluid source to the first reservoir by closing a valve
opening the venting valve of the first water reservoir,
stopping the flow of water through the turbine by closing a valve
closing the venting valve of the second reservoir,
opening the draining valve of the second reservoir
supplying pressurized fluid from a pressurized fluid source to the second reservoir by opening the source valve,
pressing water out of the second water reservoir via the conduit and into the first reservoir.

Optionally, where the first water reservoir forms a closable volume, the method comprises:

In the first step:
closing the volume of the first water reservoir by shutting the venting valve of the first water reservoir,
opening the venting valve of the second water reservoir
shutting off the connection between the pressurized fluid source and the second water reservoir by closing the second source valve
opening the first source valve supplying pressurized fluid from a pressurized fluid source to the first reservoir enhancing the hydraulic pressure in a channel/conduit leading to the turbine;
producing mechanical power by passing water through the turbine from the first water reservoir to the second water reservoir
collecting water in the second reservoir after the water has passed through the turbine
shutting off the connection to the pressurized fluid source to the first reservoir by closing the first source valve
opening the venting valve of the first water reservoir; and

In the second step:
closing the venting valve of the second reservoir,
re-configuring the channels/conduits leading water to or from the turbine for operation with water flow directed from the second water reservoir to the first water reservoir,
supplying pressurized fluid from the pressurized fluid source to the second reservoir by opening the second source valve, enhancing the hydraulic pressure in the channel/conduit leading to the turbine,
producing mechanical power by passing water through the turbine from the second water reservoir to the first water reservoir,
collecting water in the first reservoir after the water has passed through the turbine from the second water reservoir to the first water reservoir.

Optionally, where the first water reservoir forms a closable volume, the method comprises

In the first step:
closing the volume of the first water reservoir by shutting the venting valve of the first water reservoir,
opening the venting valve of the second water reservoir to the atmosphere,
shutting off the connection between the pressurized fluid source and the second water reservoir by closing the second source valve;
opening the first source valve supplying pressurized fluid from a pressurized fluid source to the first reservoir enhancing the hydraulic pressure in the channel/conduit leading to the turbine;
producing mechanical power by passing water through the turbine from the first water reservoir to the second water reservoir;
collecting water in the second reservoir after the water has passed through the turbine;
shutting off the connection to the pressurized fluid source to the first reservoir by closing the first source valve;
opening the venting valve of the first water reservoir and guiding the venting steam or gas through a turbine to extract mechanical energy, and

In the second step:
closing the venting valve of the second reservoir,
opening the venting valve of the first water reservoir to the atmosphere,
re-configuring the conduits leading water to or from the turbine for operation with water flow directed from the second water reservoir to the first water reservoir,
supplying pressurized fluid from the pressurized fluid source to the second reservoir by opening the second source valve, enhancing the hydraulic pressure in the conduit leading to the turbine,
producing mechanical power by passing water through the turbine from the second water reservoir to the first water reservoir,
collecting water in the first reservoir after the water has passed through the turbine from the second water reservoir to the first water reservoir,
opening the venting valve of the second water reservoir and guiding the venting steam or gas through a turbine to extract mechanical energy,

Optionally, where the first water reservoir forms a closable volume, the method comprises:

In the first step:
closing the volume of the first water reservoir by shutting the venting valve of the first water reservoir,
opening the venting valve of the second water reservoir
shutting off the connection between the pressurized fluid source and the second water reservoir by closing the second source valve;
opening the first source valve supplying pressurized fluid from a pressurized fluid source to the first reservoir enhancing the hydraulic pressure in the conduit leading to the turbine;
producing mechanical power by passing water through the turbine from the first water reservoir to the second water reservoir;
collecting water in the second reservoir after the water has passed through the turbine,
closing the first source valve after a fractional water volume V₁ in the first water reservoir has been passed through the turbine,
allowing the steam or gas in the first water reservoir to expand, pressing an additional volume of water V₂ through the turbine and producing mechanical power,
releasing residual steam or gas pressure in the void volume of the first reservoir by opening the venting valve,
shutting off the connection to the pressurized fluid source to the first reservoir by closing the first source valve;
opening the venting valve of the first water reservoir; and

In the second step:
closing the venting valve of the second reservoir,
re-configuring the channels/conduits leading water to or from the turbine for operation with water flow directed from the second water reservoir to the first water reservoir;
supplying pressurized fluid from the pressurized fluid source to the second reservoir by opening the second source valve, enhancing the hydraulic pressure in the conduit leading to the turbine,
producing mechanical power by passing water through the turbine from the second water reservoir to the first water reservoir,
collecting water in the first reservoir after the water has passed through the turbine from the second water reservoir to the first water reservoir,
closing the second source valve after a fractional water volume V₁ in the second water reservoir has been passed through the turbine,
allowing the steam or gas in the second water reservoir to expand, pressing an additional volume of water V₂ through the turbine and producing mechanical power,
releasing residual steam or gas pressure in the void volume of the second reservoir by opening the venting valve.

### DESCRIPTION OF THE DIAGRAMS

The above and further features of the invention are set forth with particularity in the appended claims and together with advantages thereof will become clearer from consideration of the following detailed description of exemplary embodiments of the invention with reference to the accompanying drawings, wherein:

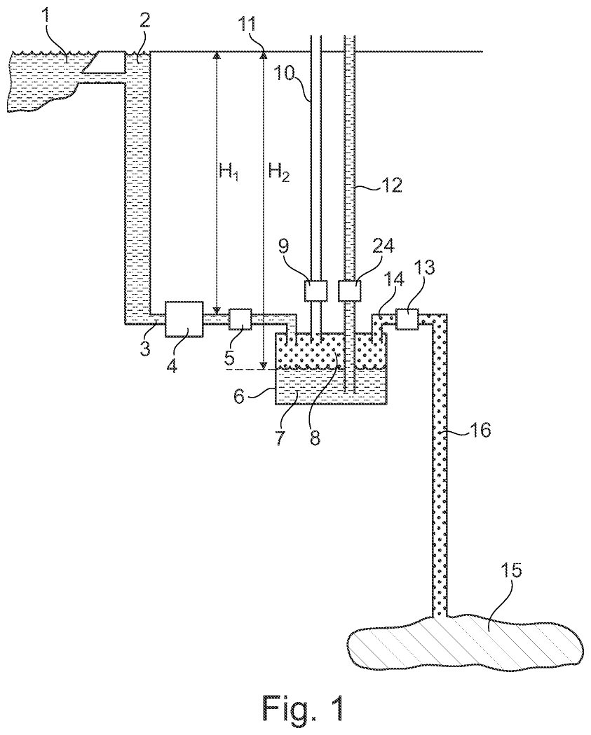

FIG. 1 discloses an embodiment of the present invention with an open first water reservoir and a closable second water reservoir.

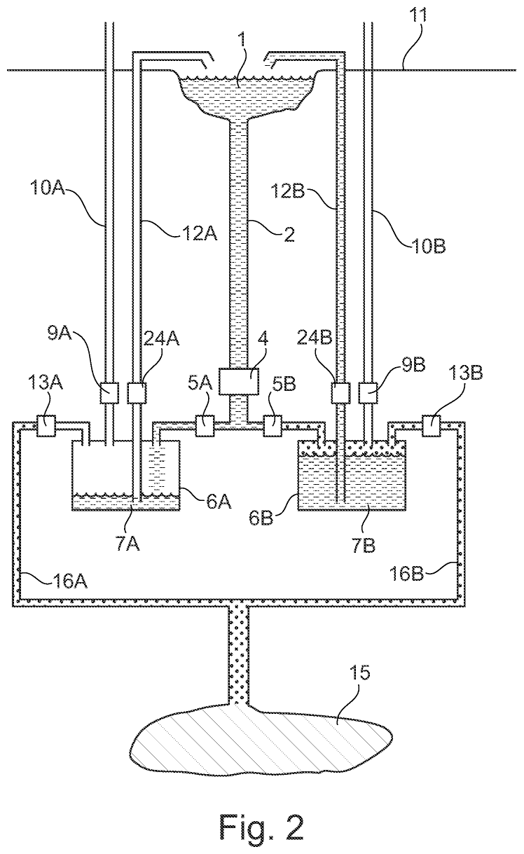

FIG. 2 discloses a version of the embodiment in FIG. 1 with coordinated operation of dual systems.

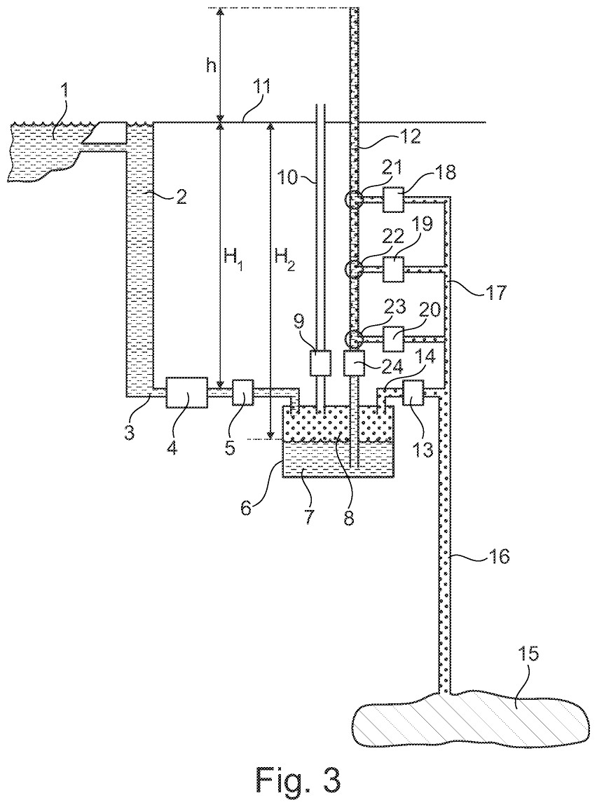

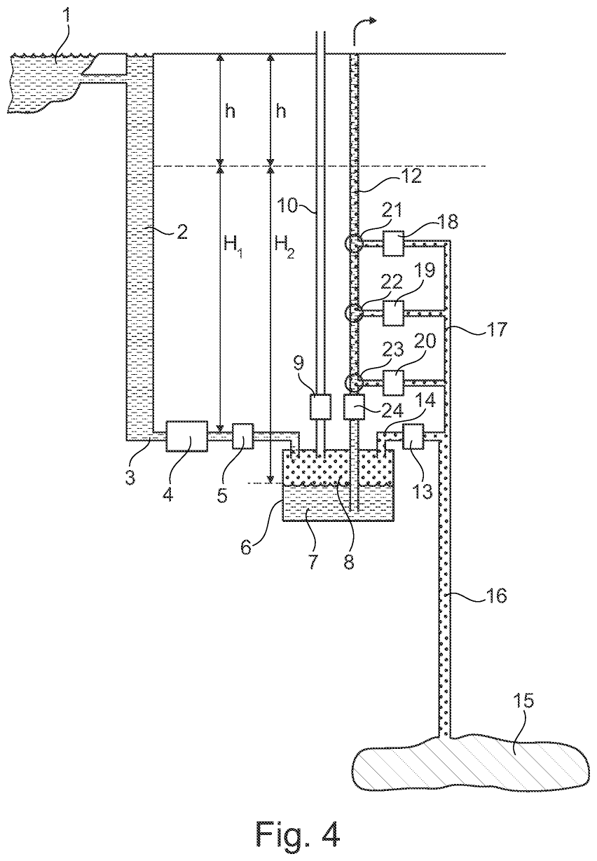

FIGS. 3, 4 disclose embodiments of the present invention employing gas or steam assisted lifting of water.

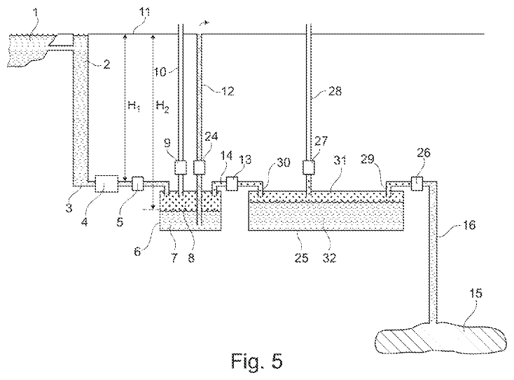

FIG. 5 discloses a generic embodiment of the present invention where energy is stored in a closable volume containing hot water and steam.

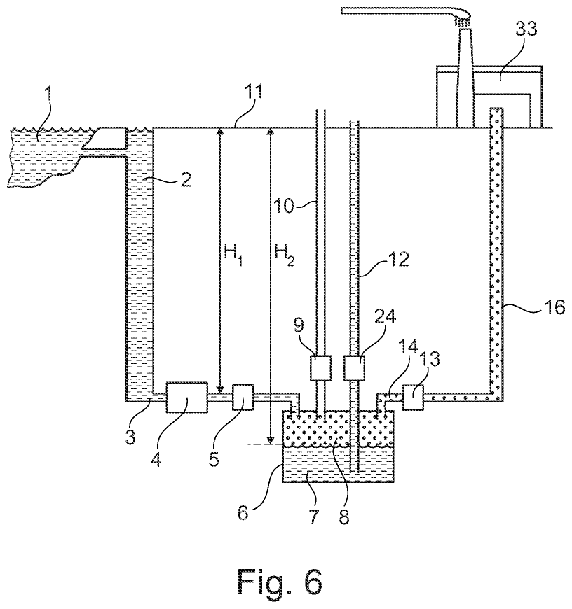

FIG. 6 discloses a generic embodiment of the present invention where hot water and/or steam and/or gas is generated in an industrial process and transported into a closable second water reservoir in the system.

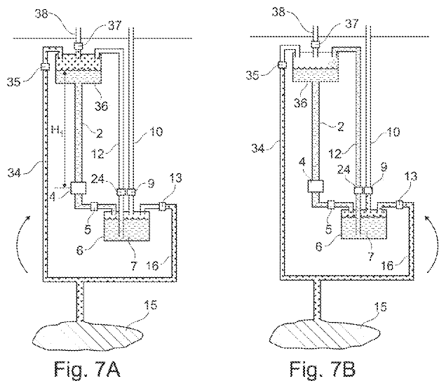

FIGS. 7a, 7b disclose two stages in an energy production process according to the present invention where a first and a second closable water reservoir are at different altitudes.

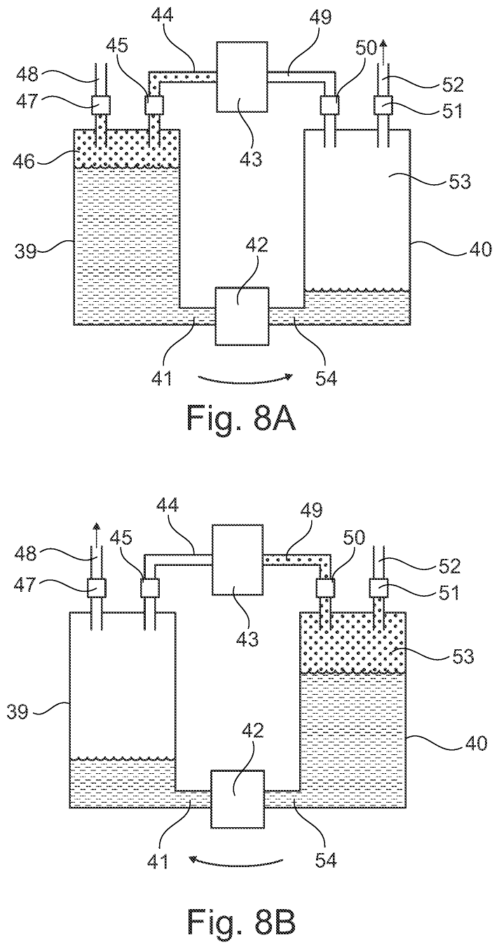

FIGS. 8a, 8b disclose two stages in an energy production process according to the present invention where a first and a second closable water reservoir are located side by side.

### LIST OF REFERENCE NUMBERS IN THE FIGURES

The following reference numbers refer to the drawings:

| Number | Designation |
|---|---|
| 1 | Reservoir |
| 2 | Vertical shaft |
| 3 | Transverse tunnel |
| 4 | Turbine |
| 5, 5A, 5B | Valve |
| 6, 6A, 6B | Reservoir |
| 7, 7A, 7B | Water |
| 8 | Air/void space |
| 9, 9A, 9B | Valve |
| 10, 10A, 10B | Venting tube |
| 11 | Surface |
| 12, 12A, 12B | Vertical shaft |
| 13, 13A, 13B | Valve |
| 14 | Tube |
| 15 | Geothermal source |
| 16, 16A, 16B | Supply shaft |
| 17 | Branching shaft |
| 18, 19, 20 | Control unit |
| 21, 22, 23 | Injection points |
| 24 | Valve |
| 25 | Thermal reservoir |
| 26 | Valve |
| 27 | Valve |
| 28 | Communicating tube |
| 29 | Entry port |
| 30 | Exit port |
| 31 | Steam/void space |
| 32 | Water |
| 33 | Industrial plant |
| 34 | Tube |
| 35 | Valve |
| 36 | Reservoir |
| 37 | Valve |
| 38 | Venting tube |
| 39, 40 | Reservoir |
| 41 | Tube |
| 42 | Turbine/generator |
| 43 | Energy source |
| 44 | Tube |
| 45 | First source valve |
| 46 | Void volume |
| 47 | Valve |
| 48 | Venting tube |
| 49 | Tube |
| 50 | Second source valve |
| 51 | Valve |
| 52 | Venting tube |
| 53 | Void volume |
| 54 | Tube |

### DESCRIPTION OF PREFERRED EMBODIMENTS OF THE INVENTION

The basic principles underlying the present invention shall now be described with reference to the simplified drawings of the system in FIGS. 1-8. Generally, an amount of steam or gas under pressure is created from an available source of thermal or mechanical energy, and the steam or gas is brought into a closed volume which is partially filled with water. The pressure of the steam or gas in contact with the water surface adds to the hydrostatic pressure in the water, and mechanical energy can be produced by allowing the water to flow through a turbine or into a riser tube which lifts the water to a higher level.

A first preferred embodiment of the invention is illustrated in FIG. 1: The system produces electrical energy in a two-part cyclic process:
In the first part of the cycle, the energy production phase, water is drawn from a first reservoir (1) into a first vertical shaft (2), the “downshaft”, where it is transported downwards by the liquid flow through the system. At the bottom of the downshaft a transverse tunnel (3) conducts the water to a turbine (4) which is connected to an electrical generator (not shown). After passing through the turbine the water is led through a valve (5) before dropping into a second reservoir (6). As the water (7) in the second reservoir rises, air (8) in the second reservoir is allowed to escape via a valve (9) and a venting tube (10) to the surface (11). This ensures that the turbine can operate without significant counterpressure. When the second reservoir has been filled to a predetermined level, the valve (5) is closed and power production stops.
In the second part of the cycle, the charging phase, water in the second reservoir is transferred to the surface through a second vertical shaft (12), the “riser shaft”, evacuating the second reservoir and thus preparing the system for a renewed production phase: The valves (5) and (9) are now closed, and a valve (13) is opened to admit gas or steam under pressure into the second reservoir via a tube (14). The valve (24) which controls the liquid flow into the riser is open in this phase. The elevated pressure in the atmosphere (8) over the water in the second reservoir forces water to enter the submerged opening of the riser shaft (12) near the bottom of the second reservoir and thereafter to rise to the surface (11). Water flowing out of the riser shaft at the surface may be returned to the first reservoir (1) or disposed of otherwise. In principle, the gas or steam under pressure that enters the second reservoir via the tube (14) may be derived from a number of different types of sources. In the preferred embodiment shown in FIG. 1, steam under pressure comes from a geothermal source (15) via a supply shaft (16). This shaft may extend up to several kilometers into the ground and connects to a deep underground geothermal reservoir of hot water and steam. This water is at an elevated pressure, corresponding to a boiling point well above 100 C. When the valve (13) opens, water in the geothermal source (15) and the supply shaft (16) experiences a pressure relief and hot water flashes spontaneously into high pressure steam. Depending on how the geothermal source (15), supply shaft (16) and valve (13) are configured, the tube (14) may eject only steam or a mixture of steam and flashing hot water into the second reservoir (6). The desired pressure p in the second reservoir is maintained by controlling the flow of steam and/or flashing hot water from the shaft (16).

The charging procedure entails lifting the water from the second reservoir a vertical height H₂, which implies that the required pressure p shall be at least:

p=ρgH₂ Eq. 1

where ρ is the density of the water in the riser shaft.

The power delivered by the turbine (4) in the energy production phase can be written:

W=Q ρgH₁ Eq. 2

where Q is the volumetric flow of water through the turbine in [m³/s], ρ is the density of the water in the downshaft (assumed here to equal that in the riser shaft) and H₁ is the vertical height of the water column in the downshaft. Assuming that the energy production phase has a duration τ₁ and the charging phase τ₂, the time averaged power delivered from the system is:

W_{average}=W τ₁/(τ₁+τ₂). Eq. 3

In order to obtain an uninterrupted production of electrical power, a plurality of systems of the type shown in FIG. 1 can be arranged to operate in a coordinated fashion, where there is always one system in the production phase while the other systems are in various stages of the charging phase. Another strategy is illustrated in FIG. 2: Here a single turbine (4) delivers uninterrupted power by tailrace water being directed sequentially between two second reservoirs (6A) and (6B) that are prepared to receive the water in a coordinated sequence. FIG. 2 shows an instant in time where the valve (5A) is open and (5B) is closed, and water passing through the turbine (4) is directed into the second reservoir (6A). The valves (13A) and (24A) are closed, and (9A) is open. At the same time, water is pumped out of the second reservoir (6B): Valves (5B) and (9B) are closed and (24B) and (13B) are open. Steam from the geothermal source (15) is admitted into the second reservoir (6B), exerting pressure on the water (7B) and causing water to exit through the riser shaft (12B). When the second reservoir (6A) is full and (6B) is empty, the valve (5A) is closed and (5B) opens, and the roles of the second reservoirs are switched. By trivial extension, more than two second reservoirs may be employed in such a scheme where water from the turbine may be directed sequentially and/or in parallel between a plurality of second reservoirs in order to achieve smooth energy delivery or reach capacity goals.

According to Eq. 1 and Eq. 2 one has:

W≈QpH₁/H₂ Eq. 4

In most situations of relevance here, H₁≈H₂, and:

W≈Qp. Eq. 5

According to Eq. 5, for a given volumetric flow of water Q the turbine power W is effectively defined by the pressure p in the second reservoir, which is ultimately limited by the available steam pressure and temperature from the geothermal source. As shall now be described, the system shown in FIG. 1 can be modified and expanded to lift this limitation on the achievable turbine power W. The basic principle involved is to introduce bubbles into the riser shaft (12) by one of several methods which shall be described below. The bubbles reduce the density of the liquid in the riser shaft and provide a pumping action via their buoyancy. Expansion of the bubbles as they rise shall cause cooling and draw energy from the water, increasing energy yield. Both effects shall contribute to increasing the height H₂ of the column which can be lifted by a given second reservoir pressure p. This in turn allows an increase in the head of water driving the turbine and thus its peak power capability.

In a first preferred embodiment employing this principle, gas bubbles are mixed into the water in the second reservoir (6). The bubbles are by design sufficiently small to remain suspended in the water for a period of time such that they are carried with the water as it enters and flows up in the riser shaft (12). Preferably, the bubbles are introduced into the water in the second reservoir during the energy production phase or shortly thereafter when the pressure in the second reservoir is low, to avoid introduction of the gas against a high counterpressure. Admixture of bubbles may occur in the water being expelled from the turbine and/or by means of bubble generators in the second reservoir. Optionally, a compression stage may follow the bubble admixing process by closing the valve (9) and running the turbine briefly to pressurize the second reservoir by means of an added volume of water before admitting steam through the valve (13).

In a second preferred embodiment employing this principle, gas bubbles are seeded directly into the water in the riser shaft (12) with the valve (24) open. In the example shown in FIG. 3 bubbles can be fed into the riser shaft at injection points (21), (22), (23) under the control of units (18), (19), (20), and the bubble gas is steam delivered from the supply shaft (16) via the branching shaft (17). In principle the bubble gas may be derived from any other sources of gas as long as the gas pressure exceeds the hydrostatic pressure at the point of injection into the riser shaft. Multiple injection points as shown in FIG. 3 provide flexibility in controlling the two-phase flow in the riser shaft. When steam is used, it is particularly important to control the injection process: Too small bubbles shall condense in the water and vanish, while too large bubbles shall waste energy and cause foaming.

As illustrated in FIG. 4, the combined actions of steam pressure in the second reservoir and bubble lift in the riser shaft shall cause the level of the bubble-containing water to rise to a height h above the level it would have reached by the steam pressure in the second reservoir alone (i.e. H₂→H₂+h) and the pumping capacity in the riser shaft shall be enhanced correspondingly. A consequence of this is that the system shall be able to operate with a higher head of water (i.e. H₁→H₁+h) driving the turbine (4), and thus a higher specific power. This is illustrated in

FIG. 4 which shows a system similar to that shown in FIG. 3, but where the downshaft and riser shafts have been extended by a height h.

FIG. 5 shows a preferred embodiment of the present invention where hot water and steam from a geothermal source (15) is collected and stored before being injected into the second reservoir (6). The overall system is similar to that shown in FIG. 1, but includes a thermal reservoir (25) which receives hot water from the geothermal source (15) via a controlling valve (26) and the entry port (29). When the valve (13) is opened, some of the water (32) in the thermal reservoir flashes to steam (31) which is expelled through the exit port (30) and into the second reservoir (6). The system includes a valve (27) and a communicating tube (28) to the surface (11). The temperature of the water in the thermal reservoir may typically be in the range 140 C and above, with a saturation steam pressure above 3.5 bar. In order to retain large amounts of thermal energy over extended time periods, the thermal reservoir shall be thermally insulated and sealed against pressure loss. One notes that a large underground cavity may be designed to represent a favorable volume to surface ratio (e.g. spherical), and can be located at a depth that avoids danger to persons at the surface.

As shall be apparent to a person skilled in the art, the basic elements and procedures of the energy systems according to the present invention can also function in cases where the thermal energy is derived from other sources than geothermal. Thus, waste heat from combustion processes in thermal power plants or industry can be transported in hot steam or gas directly into the second reservoir (6) as shown in FIG. 6 where hot steam is carried from an industrial plant (33) on the surface to the second reservoir (6) via a thermally insulating duct (16). Alternatively, hot steam, liquid or gas can be transported into a heat exchanger immersed in the thermal reservoir (25) in FIG. 5, or electrical energy may be used to heat the water in the thermal reservoir (25) by means of a resistance coil. This would be relevant, e.g. when abundant electrical energy from intermittent sources such as wind and solar is available and needs to be stored.

Generally, a person skilled in the art shall be aware of strategies that can be implemented for preserving thermal energy in the various aspects of the present invention, including thermal insulation and scaling effects as referred above. Particular to several of the preferred embodiments of the present invention is the existence of interfaces between hot steam and cold water surfaces where heat transfer from steam to water must be minimized. In these cases, heat resistant, thermally insulating particles that float as a thermal barrier layer on top of the water may be used. A particular feature of the embodiments in question is that systems may be operated in such a fashion so as to avoid that the floating particles are lost during the cycling operations, e.g. by avoiding water levels to become too low and avoiding strong turbulence in the cavities holding water.

Another preferred embodiment of the present invention is illustrated in FIGS. 7A, 7B: FIG. 7A shows the energy production phase of a cyclic process where water passes through the turbine (4) and is collected in the second reservoir (6). In this case water is drawn from the first reservoir (36), which is a sealed cavity with fluid flow through entrance and exit ports controlled by valves: In the energy production phase, valves (35), (5) and (9) are open and valves (37), (24) and (13) are closed. Steam from the geothermal source (15) enters the first reservoir (36) via the tube (34). Since the valves (37), (24) are closed, pressure builds up in the void volume above the water surface in the first reservoir. This pressure, p_{Reservoir}, adds to the hydrostatic pressure ρgH₁ due to the column H₁ of water in the downshaft (2), and the total pressure at the water intake of the turbine (4) is:

p_{Turbine}=p_{Reservoir}+ρgH₁ Eq. 6

The power delivered by the turbine is:

W=Q p_{Turbine} Eq. 7

where Q is the volumetric flow of water through the turbine in [m³/s]. As can be seen by comparison with Eq. 2, the power is boosted. FIG. 7B shows the charging phase of the cyclic process in this preferred embodiment. Valves (35), (5) and (9) are now closed and valves (37), (24) and (13) are open. Steam from the geothermal source (15) enters the second reservoir (6) via the valve (13) and pressure builds up in the void volume above the water surface in the second reservoir. This forces water from the second reservoir to enter the riser tube (12) and empty into the first reservoir (36), while displaced air exits via the valve (37) and the venting tube (38), thus preparing the system for a new power cycle.

Yet another preferred embodiment of the present invention, termed the “shuttle concept” here, is illustrated in FIGS. 8A, 8B: The system comprises two reservoirs (39), (40) that are connected at their lower parts via conduits (41), (54) leading to a water turbine/generator (42). In FIG. 8A the reservoir (39) functions as a first water reservoir and the reservoir (40) as a second reservoir in the first part of a two-part cycle where water is passed through the turbine, producing electrical power. In this first part of the cycle, steam or gas is generated from an energy source (43) and led through a tube (44) and an open first source valve (45) into the void volume (46) above the water surface in the first reservoir (39). The valve (47) controlling access to the venting tube (48) is closed, and pressure builds up in the void volume (46), forcing the water in the first reservoir (39) to pass through the turbine and into the second reservoir (40). The internal volume of the latter is at atmospheric pressure since the venting valve (51) is open and the second source valve (50) is closed during this part of the cycle. The turbine is subjected to the differential pressure between the reservoirs (39) and (40) and can deliver power as long as there is water available in the first reservoir (39). At a certain point when the water level has reached a predetermined low level, the flow is stopped according to a predetermined procedure (e.g. closing a valve not shown in FIG. 8A), and the second part of the two-part cycle begins. As shown in FIG. 8B, the roles of the reservoirs (39), (40) are now reversed, with water flowing from reservoir (40) which now takes the role as first reservoir and into reservoir (39) which now acts as second reservoir. The turbine produces power as before, but now the direction of the water flow is reversed. This reversible operation can be achieved either by using a reversible turbine or a system for redirection of the water through the turbine (not shown). During this second part of the two-part cycle the valves (45) and (51) are closed and valve (47) is open. The second source valve (50) is open, admitting steam or gas from the energy source (43) via the tube (49) and into the void volume (53). At a certain point, this second part of the two-part cycle ends, the water flow is stopped and a new cycle begins.

Some salient features of the shuttle concept are listed below:
Water is circulated and re-used in a closed cycle, allowing operation anywhere without need for a large water supply. Evaporation losses must be taken into account, however.
A basic two-reservoir system as shown in FIGS. 8A, 8B must interrupt power production during the time when the direction of the water flow is undergoing reversal. Continuous power delivery can be achieved by coordinating two or more systems to produce power in staggered sequence.
Since the shuttle concept is not dependent on a gravity-generated head of water, the reservoirs may be localized with a large degree of freedom, without regard to altitude above or underground. In cases where the reservoirs are tanks positioned aboveground, it may prove advantageous to employ tanks of limited size due to cost, space and security reasons. This is possible but leads to each half-cycle becoming shorter, depending on how quickly water flow through the turbine (42) exhausts the capacity of the first reservoir cavity.

Simple estimates of energy flow under the shuttle concept can be made as follows, with reference to FIG. 8A: In one scenario the steam or gas pressure p₁ in the void space (46) above the water in the first reservoir (39) is maintained constant by replenishment of steam or gas from the energy source (43) during the part of the cycle when the water in the first reservoir is forced through the turbine (42), displacing a volume V of water. The receiving volume in the second reservoir (40) is open to the atmosphere via the valve (51) and venting tube (52), thus exerting a counterpressure p_{Atm} against the turbine. The net mechanical energy generated by the turbine is:

E_{Turbine}∫p₁ dV−∫p_{Atm} dV=(p₁−p_{Atm}) V Eq. 8

When this first part of the two-part cycle is finished, the turbine stops and the steam or gas in the void volume (46) which now occupies most of the volume in the first reservoir (39) must be removed to prepare the system for the second part of the two-part cycle when the reservoir (39) shall act as a second reservoir and receive water. A simple way to achieve this is to open the vent valve (47) and release the steam or gas into the atmosphere via the venting tube (48). It must be noted, however, that this implies losing a significant amount of compressed gas energy: If a volume V of an ideal gas at initial pressure p₁ is released to the atmosphere under isothermal conditions, the exploitable gas expansion energy E_{Gas} can be written:

E_{Gas}=p₁ V ln(p₁/p_{Atm})−(p₁−p_{Atm}) V. Eq. 9

Here the second term represents work done by the expanding gas against the atmosphere. Comparing this to the net mechanical energy generated by the turbine according to Eq. 8, one has:

E_{Gas}/E_{Turbine}=p₁ ln(p₁/p_{Atm})/(p₁−p_{Atm})−1 Eq. 10

Accordingly, the ratio E_{Gas}/E_{Turbine} shall depend on p₁, tending to increase at high values of p₁. Thus, one has E_{Gas}/E_{Turbine}=1.14 at p₁=6 [bar], E_{Gas}/E_{Turbine}=1.56 at p₁=10 [bar], and E_{Gas}/E_{Turbine}=3.00 at p₁=50 [bar].

### NUMERICAL EXAMPLES

Example 1) p₁=6 [bar]=0.6 [MPa], p_{Atm}=1 [bar]=0.1 [MPa], V=1000 [m³]. Insertion into Eq. 8 and Eq. 9 yields: E_{Turbine}=0.5×10⁹ [J]=0.14 [MWh]; E_{Gas}=0.57×10⁹ [J]=0.16 [MWh];

Example 2) p₁=10 [bar]=1 [MPa], p_{Atm}=1 [bar]=0.1 [MPa], V=1000 [m³]. Insertion into Eq. 8 and Eq. 9 yields: E_{Turbine}=0.9×10⁹ [J]=0.25 [MWh]; E_{Gas}=1.4×10⁹ [J]=0.39 [MWh].

Example 3) p₁=50 [bar]=5 [MPa], p_{Atm}=1 [bar]=0.1 [MPa], V=1000 [m³]. Insertion into Eq. 8 and Eq. 9 yields: E_{Turbine}=4.9×10⁹ [J]=1.36 [MWh]; E_{Gas}=14.7×10⁹ [J]=4.08 [MWh].

It is desirable to extract electrical energy from the component E_{Gas}. This can be achieved by two different routes:
One route involves employing methods and equipment that are well known from the CAES (Compressed Air Energy Storage) industry. Thus, instead of venting the compressed steam or gas to the atmosphere via valves (47), (51) and tubes (48), (52) as shown in FIGS. 8A and 8B, the steam or gas can be directed through a turbine driving a generator to produce electricity. The turbine would start with an initial pressure at p₁ which drops towards p_{Atm} as pressure is drained from the first reservoir. Such a system could adopt directly technical solutions developed for CAES, including thermal energy management to mitigate problems related to expansion cooling. It would, however, require additional technical equipment and add complexity and costs to the overall system.
An alternative route for extracting electrical energy from the component E_{Gas} would be to follow the scheme described in connection with FIGS. 8A and 8B, but driving the turbine in two stages during the first part of each two-part cycle: In the first stage, operation is identical to that described in conjunction with FIG. 8A, but the first reservoir (39) is only partially emptied of water when the first source valve (45) is closed, cutting off further supply of steam or gas. The steam or gas that has been admitted up to this point has displaced a volume V₁ of the water in the first reservoir at pressure p₁, and the turbine has delivered an amount of energy:

E_{Turbine, 1}=∫p₁ dV−∫p_{Atm} ddV=(p₁−p_{Atm}) V₁ Eq. 11

In the second stage, the steam or gas in the first reservoir is allowed to expand, forcing an additional volume V₂ of water through the turbine (42). During the expansion from an initial volume V₁ to a final volume V₁+V₂, the pressure drops from p₁ to p₂, and one can write (ideal gas approximation):

p₂=p₁ V₁/(V₁+V₂). Eq. 12

During this second stage the turbine delivers an amount of energy which can be written (isothermal expansion and ideal gas approximation):

E_{Turbine,2}=p₁ V₁ ln(p₁/p₂)−p_{Atm} V₂ Eq. 13

=p₁ V₁ ln((V₁+V₂)/V₁)−p_{Atm} V₂

Thus, the total turbine energy becomes:

E_{Turbine}=E_{Turbine,1}+E_{turbine,2}=(p₁−p_{Atm})V₁+p₁ V₁ ln((V₁+V₂)/V₁)−p_{Atm} V₂ Eq. 14

In order for the turbine to draw out the complete exploitable energy in the compressed steam or gas, V₂ must match the volume that the compressed steam or gas at pressure p₁ in the volume V₁ would occupy if released to the atmosphere. Thus, one notes from Eq. 12 that for the special case where p₂=p_{Atm} one has:

V₂=V₁(p₁−p_{Atm})/p_{Atm}. Eq. 15

Insertion for V₂ into Eq. 13 yields:

E_{Turbine,2}=p₁ V₁ ln(p₁p_{Atm})−(p₁−p_{Atm})V₁. Eq. 16

Comparison with Eq. 9 shows that In this case all the exploitable energy in the compressed steam or gas in the first reservoir is drawn out through the turbine (42), the difference being that here the turbine extracts energy from a water flow. Thus, by driving the turbine in two stages during the first part of each two-part cycle one can in principle extract all the exploitable energy delivered from the energy source (43). In practice, some compromises must be made:
During the expansion from an initial volume V₁ to a final volume V₁+V₂, the net pressure head on the turbine drops steadily towards zero. In addition to a diminishing power delivery, this shall ultimately violate the acceptable operational parameters for the turbine and generator.
In order to allow expansion of the steam or gas from a pressure p₁ to p_{Atm}, the reservoirs (39) and (40) must be made large enough to accommodate a volume of water V₁+V₂ where V₂ is defined in Eq. 15. In cases where high pressures are employed, this may imply that the reservoirs must be very large, cf., e.g. V₁+V₂=50V₁ at p₁=50 bar.

However, significant energy recovery from the compressed steam or gas can still be achieved by selecting more moderate values of V₂, particularly at lower pressures p₁. In practice, this would involve the following steps:
Step 1: Running a volume of water V₁ through the turbine with constant pressure p₁ being maintained in the void space (46) above the water in the first reservoir by replenishment of steam or gas from the energy source (43).
Step 2: Closing the first source valve (45) and continue running the turbine under the pressure of the expanding steam or gas in the void space (46), until an additional volume V₂ of water has passed through the turbine.
Step 3: Venting the remaining pressure in the void space (46) by opening the valve (47).

As a numerical example, at p₁=10 [bar], V₁=1000 [m³] and operating at V₂=3V₁ insertion into Eq. (13) yields E_{Turbine,2}=0.30 [MWh]. This may be compared with the exploitable gas expansion energy according to Eq. (9): E_{Gas}=0.39 [MWh]. In this case the expansion step with V₂=3V₁ recovers 78% of the exploitable energy in the steam or gas, and the total energy delivered by the turbine in the two stages of the first part of each two-part cycle is E_{Turbine}=E_{Turbine,1}+E_{Turbine,2}=0.69 [MWh]. In a more moderate expansion scenario with V₂=V₁ and p₁=10 [bar], V₁=1000 [m³], the expansion step recovers 42% of the exploitable energy in the steam or gas, and the total energy delivered by the turbine in the two stages of the first part of each two-part cycle is E_{Turbine}=E_{Turbine,1}+E_{Turbine,2}=0.47 [MWh].

1. A multiphase fluid pressurized hydroelectric power generation system, comprising:
a combination of fluids in the liquid and gas phase in contact with each other;
a plurality of water reservoirs where at least one is a closeable water reservoir comprising a closeable volume i.e. a confined space where all fluid flow in and out is controlled;
a source of pressurized fluid (15, 25, 33, 43) arranged for supplying pressurized fluid to the at least one closeable water reservoir;
the at least one closeable water reservoir arranged to contain water under an atmosphere of pressurized gas or vapor,
a turbine (4, 42) with a generator for generating hydroelectric power;
the plurality of water reservoirs comprising a first (1, 36, 39) and a second water reservoir (6, 6a, 6b, 40), where the second water reservoir (6, 6a, 6b, 40) is a closable water reservoir;
a first (2, 41) and a second turbine water conduit arranged respectively between the first water reservoir (1) and the turbine (4, 42), and the turbine (4, 42) and the second reservoir (6, 6a, 6b, 40); and
a control system arranged for coordinated control of the hydroelectric power generation system, comprising means for controlling fluid flow between different parts of the system.

2. The multiphase fluid pressurized hydroelectric power generation system according to claim 1, comprising a riser conduit (12) leading from a lower part of the second water reservoir (6, 6a, 6b, 40) to a higher altitude.

3. The multiphase fluid pressurized hydroelectric power generation system according to claim 2, where the riser conduit (12) debouches into the first water reservoir (1, 36).

4. The multiphase fluid pressurized hydroelectric power generation system according to claim 2, comprising means for introduction of at least one of gas and steam bubbles in the riser conduit (12), by one or more of the following: Direct injection at one or more points in the riser conduit (12); and nucleation or boiling in the riser conduit (12), and transport of bubbles or dissolved gas in water from the second water reservoir.

5. The multiphase fluid pressurized hydroelectric power generation system according to claim 1, where the pressurized fluid comprises at least one of steam, dry gas and hot water.

6. The multiphase fluid pressurized hydroelectric power generation system according to claim 5, where the source of pressurized fluid is a geothermal source or a combustion process.

7. The multiphase fluid pressurized hydroelectric power generation system according to claim 1, where the source of pressurized fluid comprises a closable storage volume (25) for storing hot water and steam under pressure, with conduits leading into the first and/or second water reservoir.

8. The multiphase fluid pressurized hydroelectric power generation system according to claim 7, where the closable storage volume (25) comprises means for receiving thermal energy from an energy source (15, 33, 43) in the form of hot water, steam, flue gas or an electric heater.

9. The multiphase fluid pressurized hydroelectric power generation system according to claim 1, comprising at least one additional second water reservoir (6a) which is closeable, and a turbine water conduit arranged between the turbine (4) and the additional second water reservoir (6a); where the control means is arranged for sequential or staggered use of the second water reservoirs (6a, 6b).

10. The multiphase fluid pressurized hydroelectric power generation system according to claim 1, where the first water reservoir (36, 39) is closeable.

11. The multiphase fluid pressurized hydroelectric power generation system according to claim 10, where the first water reservoir (36) is located at a higher altitude than the second water reservoir (6), and arranged to be pressurized based on pressurized fluid supplied by a source of pressurized fluid (15, 25, 33, 43), and where the system comprises a riser conduit according to one of the claims 2 to 4.

12. The multiphase fluid pressurized hydroelectric power generation system according to claim 10, where the turbine is arranged for being driven by water flow between two reservoirs that alternate as the first and second water reservoirs (39, 40), and there is no riser conduit.

13. The multiphase fluid pressurized hydroelectric power generation system according to claim 12, where the source of pressurized fluid (43) is common to both water reservoirs (39, 40).

14. A multiphase fluid pressurized hydroelectric power generation method, comprising a first and a second step cyclically repeated a number of times:
In the first step:
allowing water from a first water reservoir (1, 36, 39) passing via conduits (2, 3, 41) through a turbine (4, 42) with a generator for generating hydroelectric power, and into a second water reservoir (6, 6a, 6b, 40) forming a closable volume; and
venting the second water reservoir (6, 6a, 6b, 40) in at least parts of the first step;
In the second step:
suspending the venting of the second water reservoir (6, 6a, 6b, 40); and
supplying pressurized fluid from a pressurized fluid source (15, 25, 33, 43) to the second water reservoir (6, 6a, 6b, 40) contributing to pressing water out of the second water reservoir (6, 6a, 6b, 40).

15. The multiphase fluid pressurized hydroelectric power generation method according to claim 14, where in the second step the pressing of water out of the second water reservoir (6) comprises leading water through a riser conduit (12) from a lower part of the second water reservoir (6) to a higher altitude.

16. The multiphase fluid pressurized hydroelectric power generation method according to claim 15, comprises introducing at least one of gas and steam bubbles in the riser conduit (12).

17. The multiphase fluid pressurized hydroelectric power generation method according to claim 14, where the supplying pressurized fluid comprises storing hot water and steam under pressure in a closable storage volume (25) and leading it into at least the second water reservoir.

18. The multiphase fluid pressurized hydroelectric power generation method according to claim 14, using the second water reservoir and at least one additional second water reservoir (6a, 6b) sequentially or staggered from cycle to cycle.

19. The multiphase fluid pressurized hydroelectric power generation method according to claim 14, where the first water reservoir (36) forms a closable volume, and
In the first step:
suspending venting of the first water reservoir (36); and
supplying pressurized fluid from a pressurized fluid source (15a/b, 43a/b) to the first water reservoir (6) enhancing hydraulic pressure in the conduit (2) leading to the turbine (4);
In the second step:
suspending the supplying pressurized fluid to the first reservoir (36);
venting the first water reservoir (36); and
pressing water out of the second water reservoir (6) via the riser conduit (12) and into the first reservoir (36).

20. The multiphase fluid pressurized hydroelectric power generation method according to claim 14, where the first water reservoir (39) forms a closable volume, and
In the first step:
suspending venting of the first water reservoir (39);
supplying pressurized fluid from a pressurized fluid source (43a/b) to the first water reservoir (39) enhancing hydraulic pressure in the conduit (41) leading to the turbine (4); and
allowing water from the first water reservoir (39) passing via the conduit (41) through the turbine (42) with the generator for generating hydroelectric power, and into the second water reservoir (40);
In the second step:
suspending the supplying pressurized fluid to the first reservoir (39);
venting the first water reservoir (39); and
allowing water from the second water reservoir (40) passing via the conduit (54) through the turbine (42) with the generator for generating hydroelectric power, and into the first water reservoir (39).

21. The multiphase fluid pressurized hydroelectric power generation method according to claim 14, comprising guiding of steam or gas from the venting of at least one of the first and the second water reservoir through a turbine for extracting mechanical energy.

22. The multiphase fluid pressurized hydroelectric power generation method according to claim 14, comprising for at least one of the first and the second water reservoir in at least one of the first and the second step:
suspending the supplying pressurized fluid;
allowing steam or gas in the first or second water reservoir to expand, pressing an additional volume of water through the turbine and producing mechanical power; and
venting.
